(19) United States
(12) Patent Application Publication
(10) Pub. No.: US 2011/0271806 A1
(43) Pub. Date: Nov. 10, 2011

(54) GUTTER COVER MANUFACTURING METHODS AND APPARATUS

(75) Inventor: RICHARD L. KUHNS, Middletown, NJ (US)

(73) Assignee: RK INDUSTRIES, INC., Middletown, NJ (US)

(21) Appl. No.: 12/773,247

(22) Filed: May 4, 2010

(51) Int. Cl. B21B 15/00; B26D 7/26; B26D 5/00; B21B 1/08; B26D 1/56

(52) U.S. Cl. 83/17; 83/303; 72/203; 72/251; 83/649; 83/167; 83/76.1; 83/37

(57) ABSTRACT

Methods and apparatus for manufacturing articles, such as gutter covers, from a flat feedstock are provided herein. In some embodiments, an apparatus for fabricating articles having apertures from a flat feedstock may include an uncoiler to supply a flat feedstock in roll form; a first flying press configured to receive the feedstock, wherein the first flying press houses a tool and die to form one or more apertures in the feedstock; a roll former configured to pull the feedstock from the uncoiler and through the flying press, the roll former comprising a plurality of rollers to create a desired profile along the width of the feedstock; and a flying shear to cut the feedstock to a desired length.

### BACKGROUND

1. Field

Embodiments of the present invention generally relate to the manufacture of gutter covers.

2. Description of the Related Art

Gutter covers, such as those depicted in U.S. Pat. No. 5,339,575 and D382,944, have conventionally been fabricated using a variety of apparatus. In one conventional manufacturing method, gutter covers may be fabricated using a punch and die apparatus containing a series of manufacturing elements. For example, flat metal feedstock in coil form is introduced into a feeder which straightens the metal, which is subsequently fed in a prescribed length to a large press that forms the apertures and cuts the gutter cover to a prescribed length. The fabricated sheet with prescribed apertures is then formed with prescribed radius bends one at a time in a manually operated break.

However, the inventor has observed that due to the size and weight (approximately ten tons) of the aforementioned manufacturing elements, special rigging companies are needed to transport and deliver the equipment. Once delivered and installed, the manufacturing elements cannot easily be moved. In addition, operation of the equipment is laborious, because three men are required to operate the equipment—one to operate the press, one to operate the brake, and one to package product. Because of this lack of mobility, gutter covers must be fabricated in a facility where the equipment is located and then transported to a work site for installation, increasing the risk of damaging the finished gutter cover during transit and causing installation delays where the quantity of parts delivered is insufficient due to miscalculations, plan changes, or damage to components (for example during transit, job-site storage, and/or installation).

Therefore, the inventor has provided an improved gutter cover manufacturing apparatus that provides portability and ease of use.

### SUMMARY

Methods and apparatus for manufacturing articles, such as gutter covers, from a flat feedstock are provided herein. In some embodiments, an apparatus for fabricating articles having apertures from a flat feedstock may include an uncoiler to supply a flat feedstock in roll form; a first flying press configured to receive the feedstock, wherein the first flying press houses a tool and die to form one or more apertures in the feedstock; a roll former configured to pull the feedstock from the uncoiler and through the flying press, the roll former comprising a plurality of rollers to create a desired profile along the width of the feedstock; and a flying shear to cut the formed feedstock to a desired length.

In some embodiments, a method of fabricating gutter covers having apertures from a flat feedstock may include providing an apparatus for fabricating gutter covers having apertures from a flat feedstock having, in alignment, an uncoiler; a first flying press housing a tool and die to form one or more apertures in the feedstock; a roll former configured to pull the feedstock from the uncoiler and through the first flying press, the roll former comprising a plurality of rollers to create a desired profile along the width of the feedstock and a flying shear; metering out a desired length of a flat feedstock in roll form through the first flying press; forming one or more apertures in the feedstock using the first flying press; creating a desired profile along the width of the feedstock using the roll former; and cutting the feedstock into a finished length using the flying shear.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 is a side view one of a gutter cover manufacturing apparatus disposed on a truck in accordance with some embodiments of the present invention.

FIGS. 2-3 are schematic views of a gutter cover manufacturing apparatus in accordance with some embodiments of the present invention.

FIG. 4 is a partial side view of a gutter cover manufacturing apparatus in accordance with some embodiments of the present invention.

FIGS. 5A-B are perspective views of a gutter cover manufactured by a gutter cover manufacturing apparatus in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

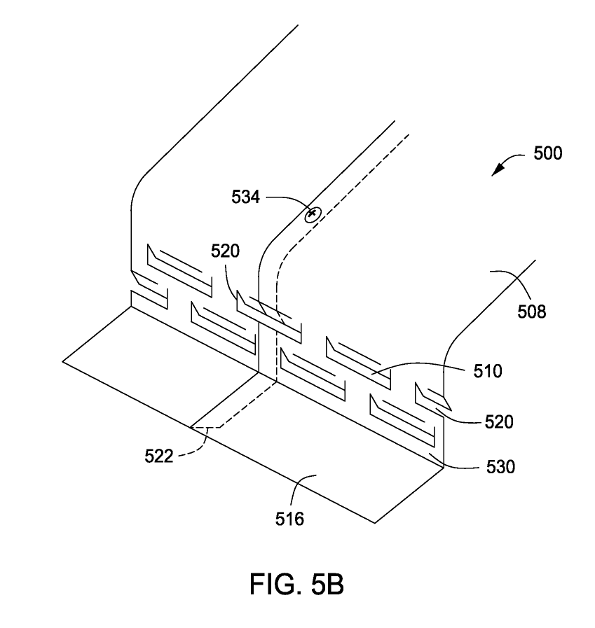

Embodiments of the present invention generally relate to the manufacture of articles having apertures from a flat feedstock. In one illustrative embodiment, embodiments of the present invention may be utilized to fabricate gutter covers, such as are depicted in U.S. Pat. No. 5,339,575, issued Aug. 23, 1994, and D382,944, issued Aug. 26, 1997, or any other gutter cover containing one or more rows of apertures (see, for example, gutter cover 500 depicted in FIGS. 5A-B). The inventive apparatus may advantageously provide a comparably lightweight, portable apparatus for manufacturing gutter covers.

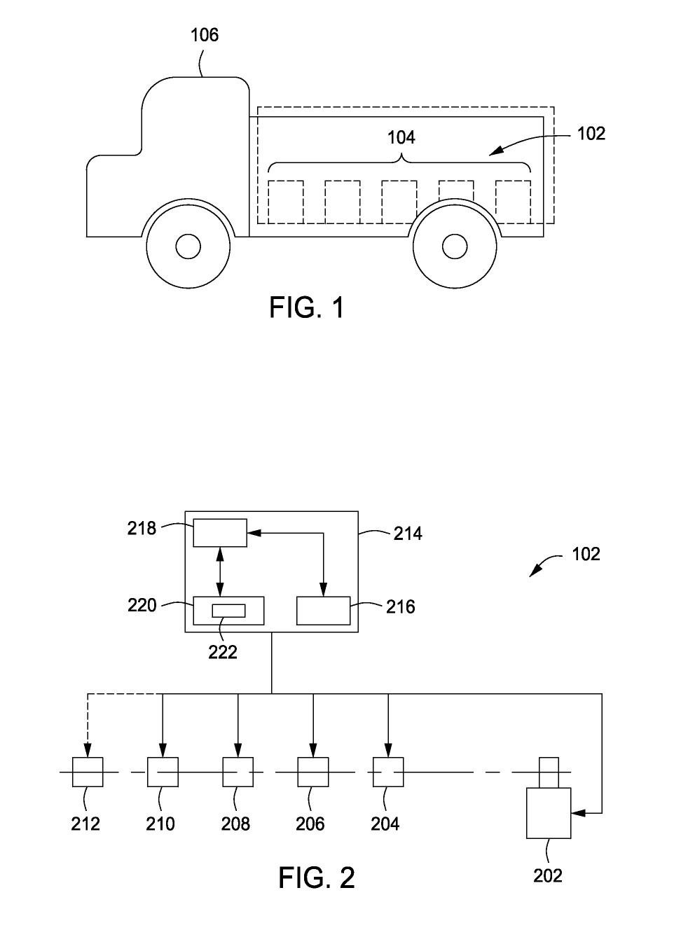

FIG. 1 is a side view one of an apparatus for manufacturing gutter covers in accordance with some embodiments of the present invention. In some embodiments, a gutter cover manufacturing apparatus 102 may generally comprise a plurality of task-specific manufacturing elements 104 arranged in a specific order to manufacture items from flat metal stock, for example, such as the gutter covers depicted in FIGS. 5A-B. In some embodiments, for example, as depicted in FIG. 1, the gutter cover manufacturing apparatus 102 may be mounted in or on a vehicle 106, for example, a pickup truck, box truck, trailer, or the like. In some embodiments, the gutter cover manufacturing apparatus may have a total weight of less than about 3,000 pounds or in some embodiments, less than about 2,000 pounds. The inventive apparatus may be handled by a fork lift or similar equipment and placed in or on a truck without using the entire load capacity of the truck. As such, additional equipment, such as the gutter raw material and other equipment that may be desired to be carried to a worksite may also be carried in the same truck as the inventive gutter cover manufacturing apparatus. Of course, the inventive apparatus may also be used within a factory or warehouse setting as well without being placed on a truck.

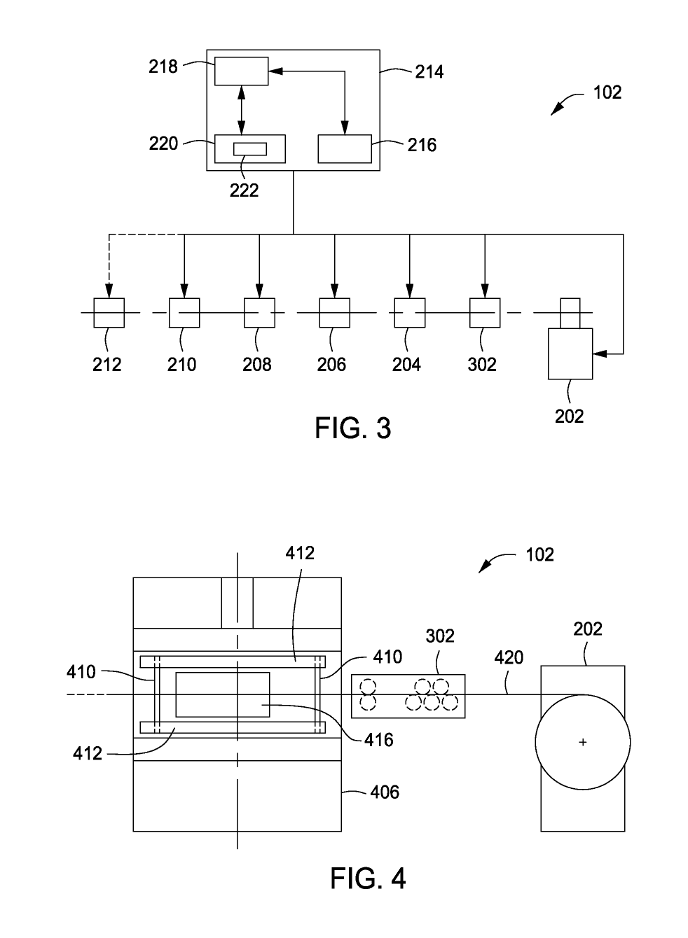

In some embodiments, the gutter cover manufacturing apparatus 102 may generally comprise an uncoiler 202, at least one flying press (two shown) 204, 206, a roll former 208, and a flying shear 210 for cutting the feedstock to a desired length, as depicted in FIG. 2. In some embodiments, a controller 214 may be coupled to one or more of the manufacturing elements to control operation thereof.

The uncoiler 202 may be a powered or unpowered uncoiler, such as are commercially available through companies such as ASC Machine Tools, Inc., of Spokane Valley, Wash., and the like. In addition, uncoilers are typically available through most metal handling industrial supply houses such as Rapid Air, of Rockford, Ill. The uncoiler 202 may be mounted horizontally, such that a shaft or mandrel for holding a coil of feedstock, or material, (not shown) is horizontal to the floor. In some embodiments, the uncoiler 202 is motorized and controlled by a set of micro switches or a photo beam that controls the uncoiler 202 as it uncoils material to be provided to other manufacturing elements 104. In some embodiments, the uncoiler 202 is unpowered and material to be provided to other manufacturing elements 104 is pulled off of the uncoiler by other equipment, as discussed below.

In some embodiments, one or more micro switches (not shown) may be configured to prevent the uncoiler 202 from uncoiling excess feedstock, thereby preventing the feedstock to sag excessively or bend as it is uncoiled from the uncoiler 202 and fed to the next manufacturing element, for example, the at least one flying press 204, 206. In such embodiments, if the feedstock sags a predetermined amount as it is fed from the uncoiler 202, a micro switch turns off the feed of feedstock. As the at least one flying press 204, 206 uses up the feedstock, the excess feedstock disposed between the uncoiler 202 and the at least one flying press 204, 206 raises in elevation to the location of a second micro switch which turns on the uncoiler 202, causing it to resume feeding feedstock. In such embodiments, a servo feed or air feed is required to prevent the roll former from pulling the material off of the uncoiler at a constant rate. Also, in embodiments using a servo feed or air feed, the flying presses and flying shear are not required. Also in such embodiments, a straightener might be included (such as straightener 302, discussed below with respect to FIG. 3).

It is contemplated that any method of controlling the uncoiler 202 may be utilized, including photo cell technology, control arms that may be included as a part of uncoiler 202, other arrangements of micro switches, and the like. It is further contemplated that the uncoiler 202 may be un-motorized and/or mounted vertically, such as in a pallet reel format, also commercially available from companies such as Rapid Air, of Rockford, Ill., such that one of the other manufacturing elements (for example, the roll former 208 as described below) is configured to pull the feedstock from the uncoiler 202 as needed without having the necessity of a loop in the coil to make up for different speeds of the equipment.

In some embodiments, the at least one flying press 204, 206 comprises one or more approximately two-ton or less flying presses. The at least one flying press 204, 206 may be any commercially available flying press suitably modified and configured to create the desired size and shape apertures of features in the feedstock in a continuous flow operation. In some embodiments, each of the at least one flying press 204, 206 may generally comprise at least one movable tool and die controlled, for example, by one or more hydraulic parts configured to form one or more apertures in the feedstock with each stroke of the at least one flying press 204, 206 while the feedstock is moving through the apparatus.

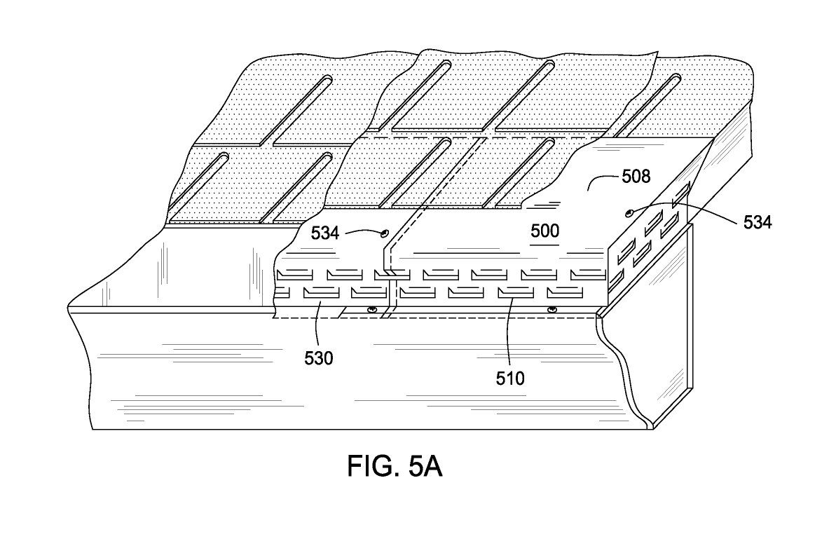

For example, as depicted in the exemplary partial side view of the gutter cover manufacturing apparatus 102 in FIG. 4, a flying press 406 suitable for use with the gutter cover manufacturing apparatus 102 may comprise a movable tool and die 416 encapsulated by connecting members 410 in a housing unit 412. The movable tool and die 416 is configured to form one or more apertures (for example, the one or more apertures 510, 520 as depicted in FIGS. 5A-B) with each stroke and may comprise of one or more independent sections that are configured to separate the parts and optionally to make any apertures, notches or holes that may be specified to be located at the end of the parts. For example, in some embodiments, a first independent section of the movable tool and die 416 may be configured to form the one or more apertures as described above and a second independent section of the movable tool and die 416 may be configured to form one or more notches and/or holes (e.g., the one or more apertures 510, 520 and/or holes 534 as depicted in FIGS. 5A-B). The independent sections of the movable tool and die 416 may be disposed adjacent to each other or separated by other components. The movable tool and die 416 may create both apertures and notches located at the end of the part of the feedstock 420 being cut off and the beginning of the part of the feedstock 420 being moved through the flying press 406.

In embodiments where the feedstock is cut off (for example, by the presses) before the roll former, a feed source such as an air feed or servo feed is required between the straightener or uncoiler and the first press. In such embodiments, stationary presses are used instead of flying presses. In embodiments where the feedstock is not cut off in the press (e.g., the presses only form the notches and the adjoining holes), then the presses can be flying presses. In such embodiments, the flying shear 210 is used to separate the parts.

Referring back to FIG. 2, in embodiments where more than one flying press 204, 206, for example two, is utilized, each of the at least one flying press 204, 206 may be similar in size, or differ in size, and may perform the same, or a different, function. For example, in some embodiments a first flying press 204 may perform the aperture forming process as described above. In such embodiments, the second flying press 206 may contain a tool and die configured to cut the feedstock to a desired length and/or make additional apertures or notches that may be specified to be located at either the beginning or end of a section of feedstock. For example, in addition to cutting the feedstock to desired length, the second flying press 206 may be used to form apertures and notches (e.g., the apertures 510, 520, and notches 522 depicted in FIGS. 5A-B). The flying presses are not required if one of these presses cuts the feed stock to length.

In operation, for example, as the feedstock is moving through the at least one flying press 204, 206, a signal indicating the position of the feedstock causes the at least one flying press 204, 206 to perform a stroke, thereby forming at least a portion of a total amount of the one or more apertures. In some embodiments, the flying press 204, 206 is configured to stroke while moving laterally at a substantially similar speed as that of the feedstock, thereby allowing the at least one flying press 204, 206 to form the one or more apertures without having to significantly slow the progression of the feedstock through the gutter cover manufacturing apparatus 102. This signal and stroke series may occur any amount of times and at any frequency sufficient to create the desired number of apertures or features in the feedstock. In some embodiments, a prescribed number of signal and stroke series may be programmed into the controller 212.

In some embodiments, following the formation of the desired apertures and notches, the feedstock enters the roll former 208. In some embodiments, the roll former 208 generally comprises a series of rollers, for example, about four rollers, or in some embodiments, more or less than four rollers, that are configured to pull the feedstock through the roll former 208, thereby causing the material to be gradually shaped with the specified radius bends as it exits the end of the roll former 208. For example, in some embodiments, the roll former 208 may be configured to bend the material to form a front ledge 516, a front face 530, and a cover portion 508, as depicted in FIGS. 5A-B. In some embodiments, the roll former 208 may additionally comprise a feed roller in the front portion of the roll former 208 to guide the material into the main body of the roll former 208. It is contemplated that technology for roll forming is well known in the trade and that a roll former suitable for creating the bends as desired in the finished product may be manufactured by many different manufacturers with various modifications.

Additionally, or alternatively, in some embodiments, the series of rollers of the roll former 208 may be configured to supply an adequate amount of force to pull the feedstock from the uncoiler 202, through the variously configured task specific manufacturing elements described above (e.g., the at least one flying press 204, 206), and provide the feedstock to the flying shear 210, thus eliminating the need for a powered uncoiler 202 (e.g., an unpowered uncoiler may be used). In operation of such embodiments, the roll former 208 may pull feedstock from the unpowered uncoiler 202 through the at least one flying press 204, 206. The at least one flying press 204, 206 may then form one or more apertures (e.g., the one or more apertures 510, 520 and/or holes 534 as depicted in FIGS. 5A-B) in the feedstock. The roll former 208 then feeds the feedstock to the flying shear 210 where one or more notches (e.g., notch 522 as depicted in FIG. 5B) may be formed and the feedstock is cut into a desired length, as described below. Alternatively, or in combination, in some embodiments, the at least one flying press 204, 206 may be configured to form the one or more notches and/or holes in addition to the apertures. In such embodiments, any or all of the at least one flying press 204, 206 may be configured such that each of the independent sections is configured to form at least one of the one or more notches, holes, or apertures, as described above with respect to FIG. 4.

In some embodiments, following the shaping of the feedstock by the roll former 208, the feedstock may be cut to a desired length by the flying shear 210. In such embodiments, as the material continuously moves through the gutter cover manufacturing apparatus 102, the flying shear 210 may be actuated, causing it to move at a substantially similar speed of the material being fed through the gutter cover manufacturing apparatus 102, thereby causing the feedstock to be cut at a desired length. In some embodiments, the actuation of the flying shear 210 may be controlled by the controller 212. The flying shear 210 may be any commercially available flying shear suitable to cut the feedstock in a continuous flow operation.

In some embodiments, after the feedstock is cut by the flying shear 210 it drops onto the collection table 212 where finished product is stacked. Optionally, the controller 214 can provide a signal and/or shut down the entire system after a prescribed number of parts are stacked, thereby providing time for manual packaging. It is also recognized that those skilled in the art may employ robotics controlled by the controller 214 to collect a prescribed number of parts and package them automatically. The controller 214 may also provide a confidential count of total parts produced for calculating royalties with or without automatic reporting features to an outside party.

The controller 214 may be used to facilitate control of the gutter cover manufacturing apparatus 102 as described above. The controller 214 may be one of any form of a general purpose computer processor used in an industrial setting for controlling various manufacturing elements, as described below. The controller 214 comprises a central processing unit (CPU) 218, a memory 220, and support circuits 216 for the CPU 218 and coupled to the various components of the gutter cover manufacturing apparatus 102 to facilitate control of the gutter cover manufacturing process. The memory 220 is coupled to the CPU 218. The memory 220, or computer-readable medium, may be one or more of readily available memory such as random access memory (RAM), read only memory (ROM), floppy disk, hard disk, or any other form of digital storage, local or remote. The support circuits 216 are coupled to the CPU 218 for supporting the processor in a conventional manner. These circuits include cache, power supplies, clock circuits, input/output circuitry and subsystems, and the like. A software routine 222, when executed by the CPU 218, causes gutter cover manufacturing apparatus 102 to perform processes, such as gutter cover manufacturing or the like, and is generally stored in the memory 220. The software routine 222 may also be stored and/or executed by a second CPU (not shown) that is remotely located from the hardware being controlled by the CPU 218. Optionally, in some embodiments, the components of gutter cover manufacturing apparatus 102 as described above may be performed manually, without the need for the controller 214.

In some embodiments, a straightener 302 may be disposed between the uncoiler 202 and the at least one flying press 204, 206, as depicted in FIG. 3. In such embodiments, straightener 302 may comprise a series of rollers 420 disposed on either side (e.g., above and below) the feedstock 420, as depicted in FIG. 4. As the feedstock passes between the rollers, the feedstock is bent in opposite directions, thereby straightening the feedstock and removing any memory of the feedstock from having been stored in roll form. In some embodiments, the rollers are adjustable to increase or decrease the degree of bend required to flatten or straighten the material. Any number of rollers suitable to perform the feedstock straightening may be provided. For example, in some embodiments, three or more rollers may be provided.

Thus, a plurality of embodiments of apparatus for manufacturing gutter covers and methods of use thereof have been disclosed. In some embodiments, the apparatus comprises, in order, an un-motorized uncoiler, a flying press, a roll former, and a flying shear. The roll former pulls material from the uncoiler and through the one flying press, which is used to form the apertures. The flying shear forms the notches and joining holes as well as cuts the piece to length. Such embodiments would fit on or in a truck.

In some embodiments, a second flying press may be positioned between the first flying press and the roll former. The second flying press may form the notches and the adjoining holes and the flying shear may be configured to cut the material to length without forming the notches and holes. Such embodiments would also fit on or in a truck.

In some embodiments, one flying press may be provided with two independent tool and die arrangements having the ability to form the apertures with a first tool and die and (on every so many strokes of the first tool and die) form the notches and the adjoining holes with a second tool and die. Such embodiments would also fit on or in a truck.

Apparatus for manufacturing gutter covers and methods of use thereof are provided herein. The present invention advantageously provides a series of equipment suitable for fabricating articles (e.g., gutter covers) which is light in weight compared to conventional equipment presently used. By reducing the overall weight, the equipment may be mounted to a vehicle (e.g., a truck or trailer), thus advantageously providing portability, and further, eliminates the need for a facility to permanently house the equipment and associated costs with respect to delivery and installation of the equipment in such a facility.

While the foregoing is directed to embodiments of the present invention, other and further embodiments of the invention may be devised without departing from the basic scope thereof.

I claim:

1. An apparatus for fabricating articles having apertures from a flat feedstock, comprising:
an uncoiler to supply a flat feedstock in roll form;
a first flying press configured to receive the feedstock, wherein the first flying press houses a tool and die to form one or more apertures in the feedstock;
a roll former configured to pull the feedstock from the uncoiler and through the flying press, the roll former comprising a plurality of rollers to create a desired profile along the width of the feedstock; and
a flying shear to cut the feedstock to a desired length.

2. The apparatus of claim 1, wherein the apparatus is mounted in or on a vehicle.

3. The apparatus of claim 1, further comprising:
a straightener disposed between the uncoiler and the first flying press to receive feedstock from the uncoiler.

4. The apparatus of claim 1, further comprising:
a second flying press disposed between the first flying press and the roll former, wherein the second flying press houses a tool and die to form one or more additional apertures in the feedstock.

5. The apparatus of claim 4, wherein the second flying press is further configured to form one or more notches along an edge of the feedstock.

6. The apparatus of claim 1, wherein the first flying press is an about two-ton press or smaller.

7. The apparatus of claim 1, wherein the roll former further comprises at least one set of feed rollers configured to pull the feedstock into the roll former.

8. The apparatus of claim 1, further comprising:
a collection table disposed proximate the flying shear, such that the finished length feedstock can be dropped into the collection table after it is cut by the flying shear.

9. The apparatus of claim 1, further comprising:
a controller configured to control one or more of the uncoiler, the first flying press, the roll former, or the flying shear.

10. The apparatus of claim 9, wherein the controller counts each part manufactured.

11. The apparatus of claim 9, wherein the controller further comprises a computer readable medium containing instructions that, when executed, cause the apparatus to fabricate sections of a rain gutter cover having a plurality of apertures and that overlap and that are configured to be fastened together proximate cut edges of the feedstock to form a gutter cover.

12. The apparatus of claim 1, wherein the apparatus has a total weight of less than about 3,000 lbs.

13. A method of fabricating gutter covers having apertures from a flat feedstock, comprising:
providing an apparatus for fabricating gutter covers having apertures from a flat feedstock having, in alignment, an uncoiler; a first flying press housing a tool and die to form one or more apertures in the feedstock; a roll former configured to pull the feedstock from the uncoiler and through the first flying press, the roll former comprising a plurality of rollers to create a desired profile along the width of the feedstock and a flying shear;
metering out a desired length of a flat feedstock in roll form through the first flying press;
forming one or more apertures in the feedstock using the first flying press;
creating a desired profile along the width of the feedstock using the roll former; and
cutting the feedstock into a finished length using the flying shear.

14. The method of claim 13, further comprising:
providing a straightener between the uncoiler and the first flying press; and
after metering out the desired quantity of the feedstock in roll form from the uncoiler, straightening the feedstock using the straightener.

15. The method of claim 13, further comprising:
forming one or more additional apertures in the feedstock using a second flying press disposed between the first flying press and the roll former.

16. The method of claim 13, further comprising:
dropping the feedstock after being cut to the finished length onto a collection table disposed proximate the flying shear.

17. The method of claim 13, further comprising:
providing a control module configured to control one or more of the uncoiler, the first flying press, the roll former, or the flying shear.

18. The method of claim 17, wherein the control module is configured to perform at least one of counting each part manufactured or adjusting the finished length of the feedstock.

19. The method of claim 13, wherein the gutter covers are sections of a rain gutter cover having a plurality of apertures and that overlap and may be fastened together proximate cut edges of the feedstock to form a gutter cover.

20. The method of claim 13, further comprising:
operating the apparatus for fabricating articles while the apparatus is disposed on a vehicle.
